(19) United States
(12) Patent Application Publication
(10) Pub. No.: US 2025/0156206 A1
(43) Pub. Date: May 15, 2025

(54) Programmatic Reprovisioning of Computing Platform Configurations

(71) Applicant: Oracle International Corporation, Redwood Shores, CA (US)

(72) Inventors: Ashok Prakash, Renton, WA (US); William R. Harper, JR., Seattle, WA (US); Gyanesh Sharma, Seattle, WA (US)

(73) Assignee: Oracle International Corporation, Redwood Shores, CA (US)

(21) Appl. No.: 18/509,506

(22) Filed: Nov. 15, 2023

(51) Int. Cl. G06F 9/455; G06F 9/445

(52) U.S. Cl. CPC G06F 9/45541; G06F 9/44505

(57) ABSTRACT

Techniques for programmatically provisioning a baremetal system are disclosed. A system receives a request to reprovision a baremetal system comprising a plurality of computing components listed in a platform definition. The system retrieves component configurations for the computing components in the platform definition. A component configuration may identify a dependency on another computing component. The system generates a dependency graph from any dependencies in the computing components. The system retrieves component configuration instructions for configuring the computing components and generates system configuration instructions based on the component configuration instructions and the dependency graph. The system reprovisions the baremetal system by executing the system configuration instructions.

### TECHNICAL FIELD

The present disclosure relates to programmatic provisioning of hardware computing platforms. In particular, the present disclosure relates to modularizing computing component configurations, and generating system configuration instructions from component configuration instructions.

### BACKGROUND

A cloud service provider may make a specific computing platform available for use by a client entity. Rather than, or in addition to a virtual machine, which can be implemented on any available suitable hardware on demand, a client entity may use and control a particular set of hardware components owned by the cloud service provider, e.g., processors, network hardware, storage devices, and so forth, referred to as a “baremetal” system. The client may make changes to many of the settings and other aspects of the baremetal system while the baremetal system is under the client's control. For example, the client may install and/or update firmware, drivers, and operating systems. The client may also store data and applications on storage devices. When the client no longer needs the baremetal system, the baremetal system may be returned to the cloud service provider. The cloud service provider may wish to reprovision the returned hardware components of the baremetal system for use by another client, for example, by erasing all software and data installed by the previous client, and installing a particular set of firmware and drivers. Manual reprovisioning may take several months, leaving the hardware components offline and unavailable for use.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 is a block diagram illustrating one pattern for implementing a cloud infrastructure as a service system, according to at least one embodiment;

FIG. 2 is a block diagram illustrating another pattern for implementing a cloud infrastructure as a service system, according to at least one embodiment;

FIG. 3 is a block diagram illustrating another pattern for implementing a cloud infrastructure as a service system, according to at least one embodiment;

FIG. 4 is a block diagram illustrating another pattern for implementing a cloud infrastructure as a service system, according to at least one embodiment;

FIG. 5 is a block diagram illustrating an example computer system, according to at least one embodiment;

FIG. 6 illustrates a system in accordance with one or more embodiments;

FIG. 7A-C illustrate an example set of operations for programmatically reprovisioning baremetal systems in accordance with one or more embodiments;

FIG. 8 illustrates an example of a platform definition in accordance with one or more embodiments; and

FIG. 9 illustrates an example of dependency graph in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. INFRASTRUCTURE AS A SERVICE
3. PROGRAMMATIC REPROVISIONING ARCHITECTURE
4. PROGRAMMATICALLY REPROVISIONING BAREMETAL SYSTEMS
5. EXAMPLE EMBODIMENT
6. PRACTICAL APPLICATIONS, ADVANTAGES, AND IMPROVEMENTS
7. COMPUTER NETWORKS AND CLOUD NETWORKS
8. MISCELLANEOUS; EXTENSIONS

### 1. GENERAL OVERVIEW

One or more embodiments reprovision a baremetal system by programmatically determining the components that make up the baremetal system, retrieving configuration information for the component, and generating and executing system configuration instructions based on the configuration information.

The system receives a request to reprovision a baremetal system. The request includes a platform definition that defines the computing components in the baremetal system. The system programmatically generates queries to retrieve component configurations for each computing component in the platform definition. A component configuration for a computing component may identify a dependency of the computing component on another computing component in the baremetal system.

The system programmatically generates a dependency graph for the baremetal system that indicates, for a given computing component, any other computing components that are dependent on the given computing component, and any other computing components on which the given computing component depends.

The system programmatically generates queries to retrieve, for each computing component, component configuration instructions for configuring the computing component. The system generates system configuration instructions based on the component configuration instructions and the dependency graph. The dependency graph determines an order in which the system is to execute the component configuration instructions. The system then reprovisions the baremetal system by executing the system configuration instructions.

One or more embodiments described in this Specification and/or recited in the claims may not be included in this General Overview section.

### 2. INFRASTRUCTURE AS A SERVICE

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

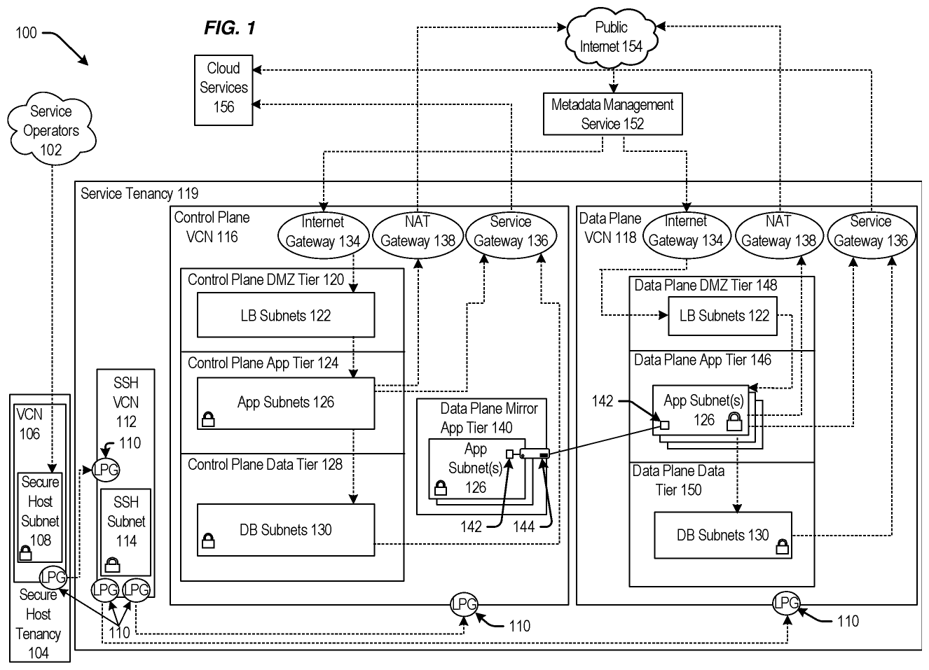

FIG. 1 is a block diagram 100 illustrating an example pattern of an IaaS architecture, according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116, and the app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way: the service gateway 136 can make API calls to cloud services 156, and cloud services 156 can send requested data to the service gateway 136. But, cloud services 156 may not initiate API calls to the service gateway 136.

In some examples, the secure host tenancy 104 can be directly connected to the service tenancy 119, which may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118, both of which may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154, which may not have a desired level of threat prevention, for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119, which may be isolated from public Internet 154.

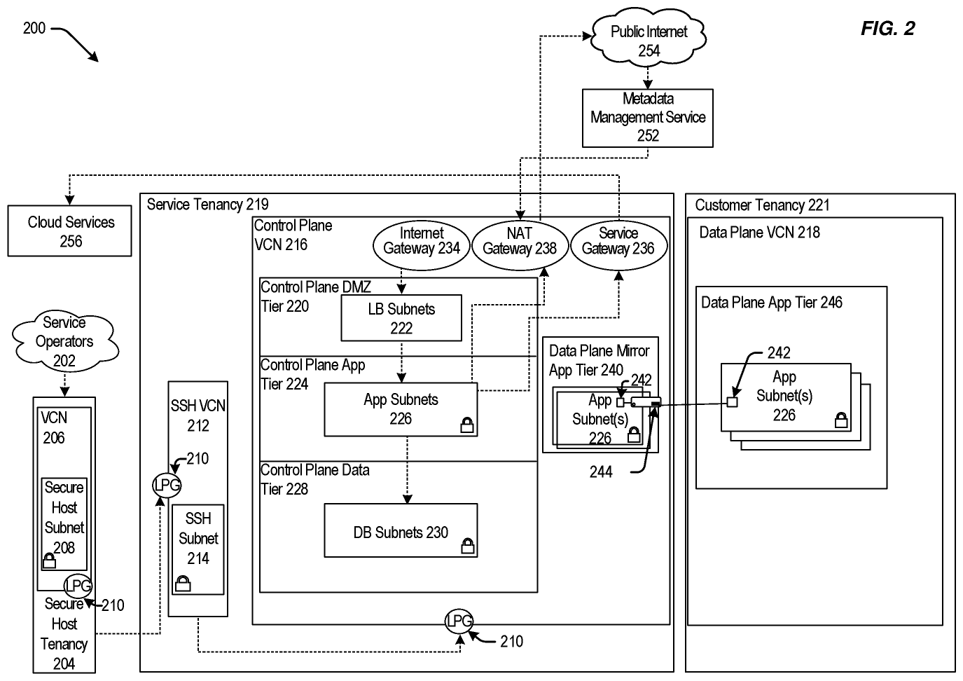

FIG. 2 is a block diagram 200 illustrating another example pattern of an IaaS architecture, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216, and the app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique compute instance 244 that is contained in the service tenancy 219. Each compute instance 244 may allow communication between the control plane VCN 216, contained in the service tenancy 219, and the data plane VCN 218 that is contained in the customer tenancy 221. The compute instance 244 may allow resources, that are provisioned in the control plane VCN 216 that is contained in the service tenancy 219, to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1,” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

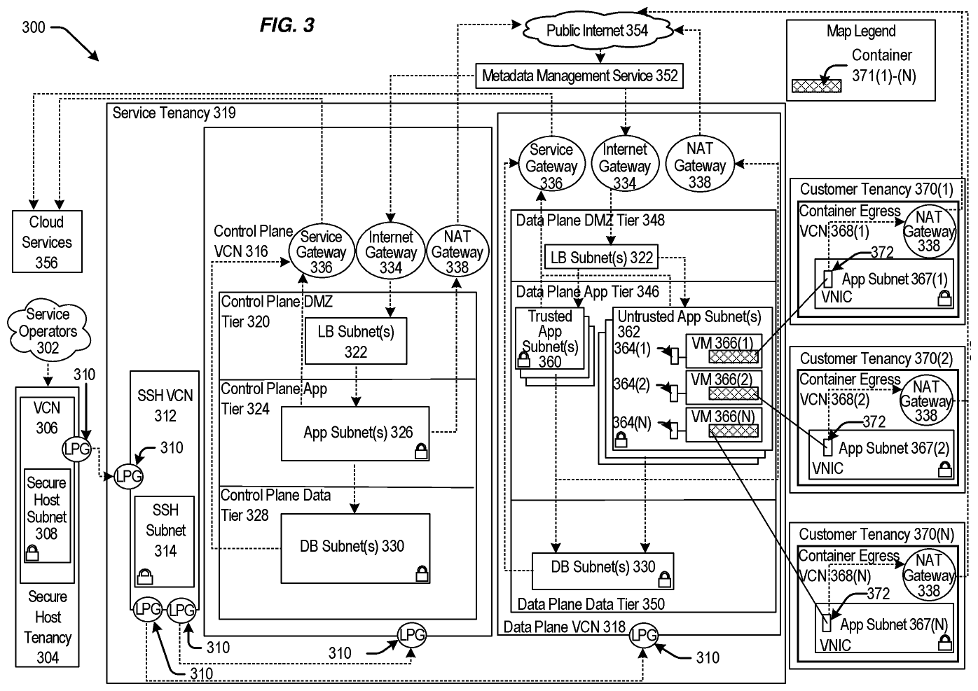

FIG. 3 is a block diagram 300 illustrating another example pattern of an IaaS architecture, according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 370(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management system 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 370. Respective containers 371(1)-(N) contained in the VMs 366(1)-(N) may be configured to run the code. In this case, there can be a dual isolation (e.g., the containers 371(1)-(N) running code, where the containers 371(1)-(N) may be contained in at least the VM 366(1)-(N) that are contained in the untrusted app subnet(s) 362), which may help prevent incorrect or otherwise undesirable code from damaging the network of the IaaS provider or from damaging a network of a different customer. The containers 371(1)-(N) may be communicatively coupled to the customer tenancy 370 and may be configured to transmit or receive data from the customer tenancy 370. The containers 371(1)-(N) may not be configured to transmit or receive data from any other entity in the data plane VCN 318. Upon completion of running the code, the IaaS provider may kill or otherwise dispose of the containers 371(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 371(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

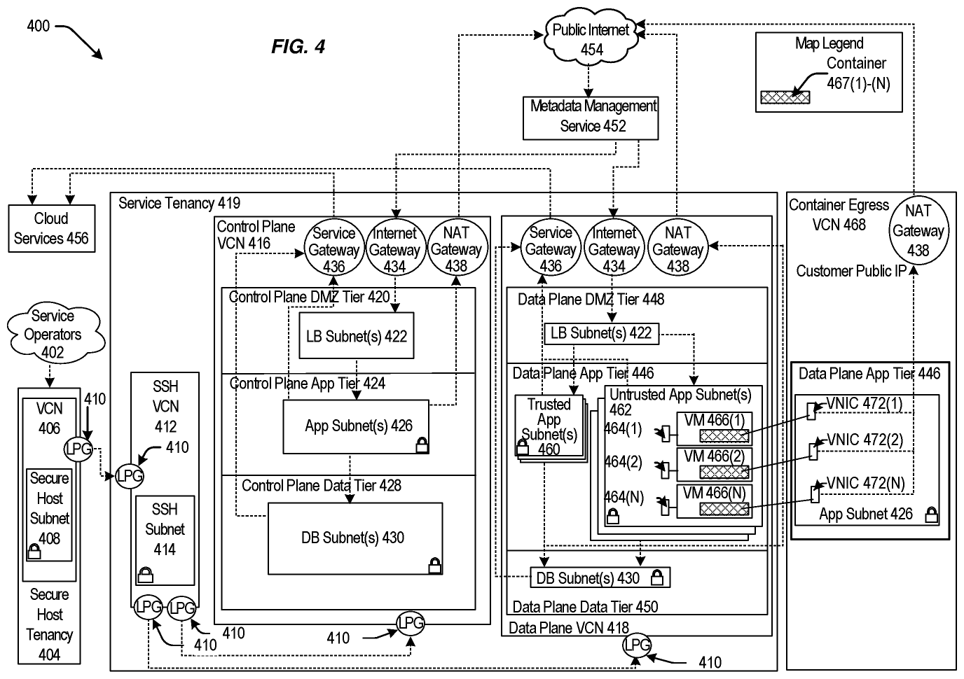

FIG. 4 is a block diagram 400 illustrating another example pattern of an IaaS architecture, according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N), and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management system 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

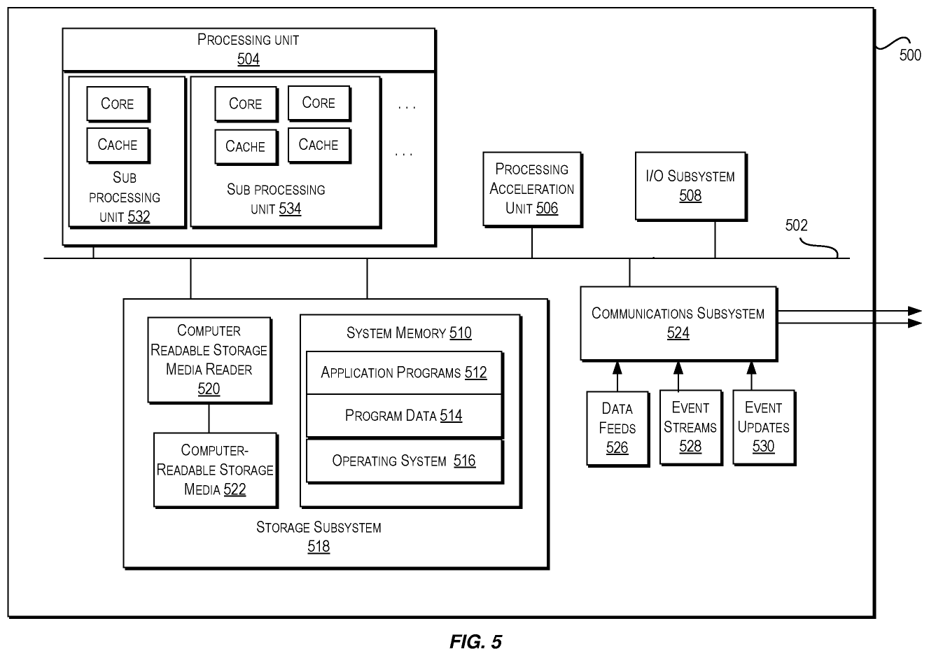

FIG. 5 illustrates an example computer system 500, in which various embodiments may be implemented. The system 500 may be used to implement any of the computer systems described above. As shown in the figure, computer system 500 includes a processing unit 504 that communicates with a number of peripheral subsystems via a bus subsystem 502. These peripheral subsystems may include a processing acceleration unit 506, an I/O subsystem 508, a storage subsystem 518 and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which can be implemented as one or more integrated circuits (e.g., a conventional microprocessor or microcontroller), controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some or all of the program code to be executed can be resident in processor(s) 504 and/or in storage subsystem 518. Through suitable programming, processor(s) 504 can provide various functionalities described above. Computer system 500 may additionally include a processing acceleration unit 506, which can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components including a system memory 510, computer-readable storage media 522, and a computer readable storage media reader 520. System memory 510 may store program instructions that are loadable and executable by processing unit 504. System memory 510 may also store data that is used during the execution of the instructions and/or data that is generated during the execution of the program instructions. Various different kinds of programs may be loaded into system memory 510 including but not limited to client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 510 may include a basic input/output system (BIOS) containing basic routines that help to transfer information between elements within computer system 500, such as during start-up.

Computer-readable storage media 522 may represent remote, local, fixed, and/or removable storage devices plus storage media for temporarily and/or more permanently containing, storing, computer-readable information for use by computer system 500 including instructions executable by processing unit 504 of computer system 500.

Computer-readable storage media 522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments communications subsystem 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 524 may also be configured to receive data in the form of continuous data streams, which may include event streams 528 of real-time events and/or event updates 530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 3. PROGRAMMATIC REPROVISIONING ARCHITECTURE

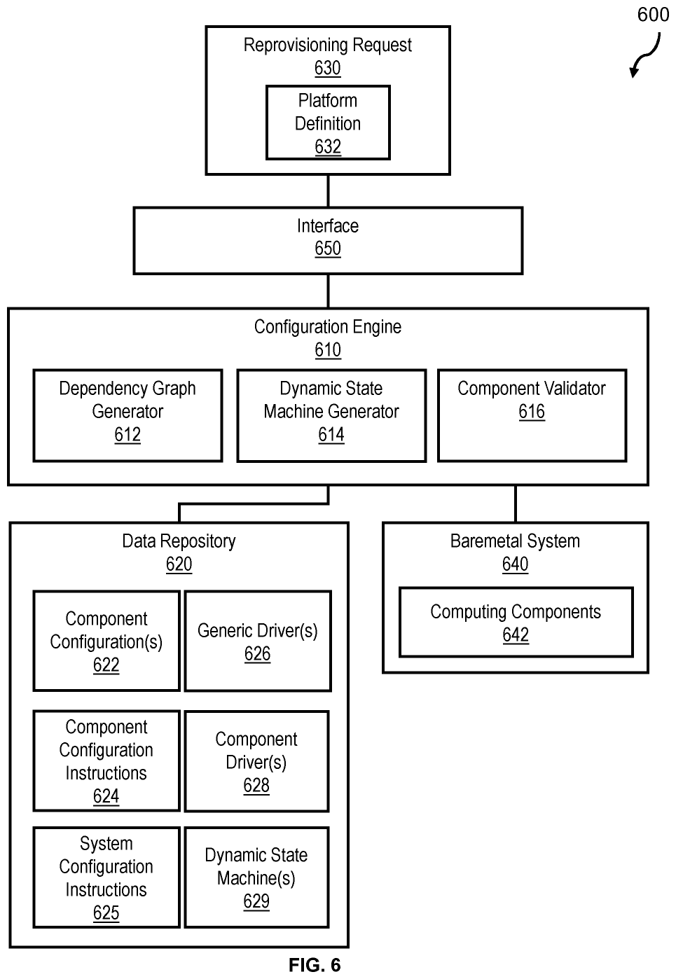

FIG. 6 illustrates a system 600 in accordance with one or more embodiments. As illustrated in FIG. 6, system 600 includes a configuration engine 610, a data repository 620, a baremetal system 640 and an interface 650. The configuration engine 610 may include one or more functional components, such as a dependency graph generator 612, a dynamic state machine generator 614, and a component validator 616. In one or more embodiments, the system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component.

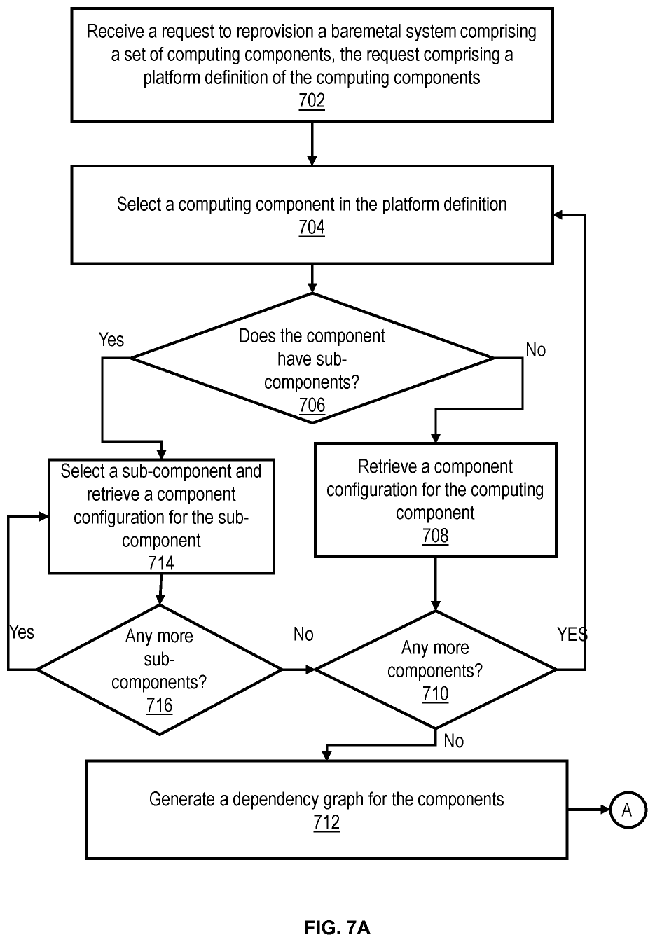

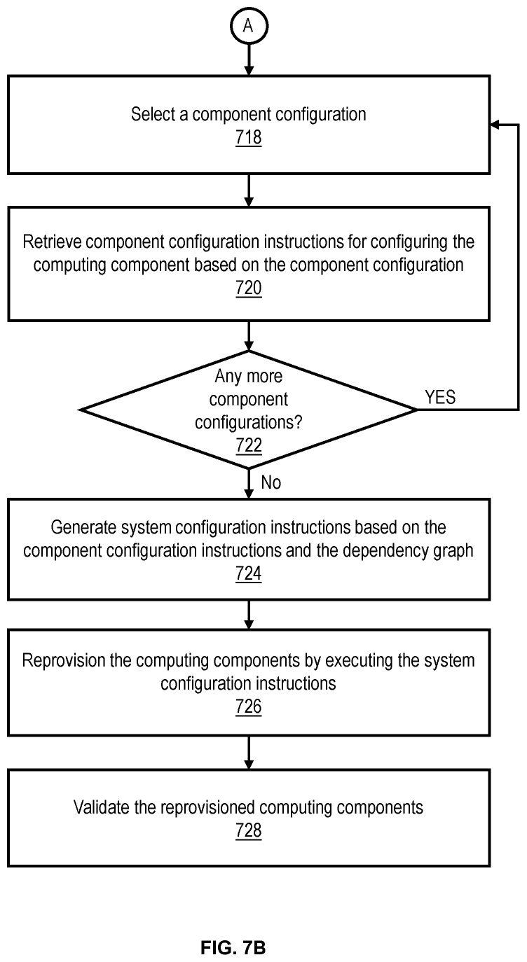

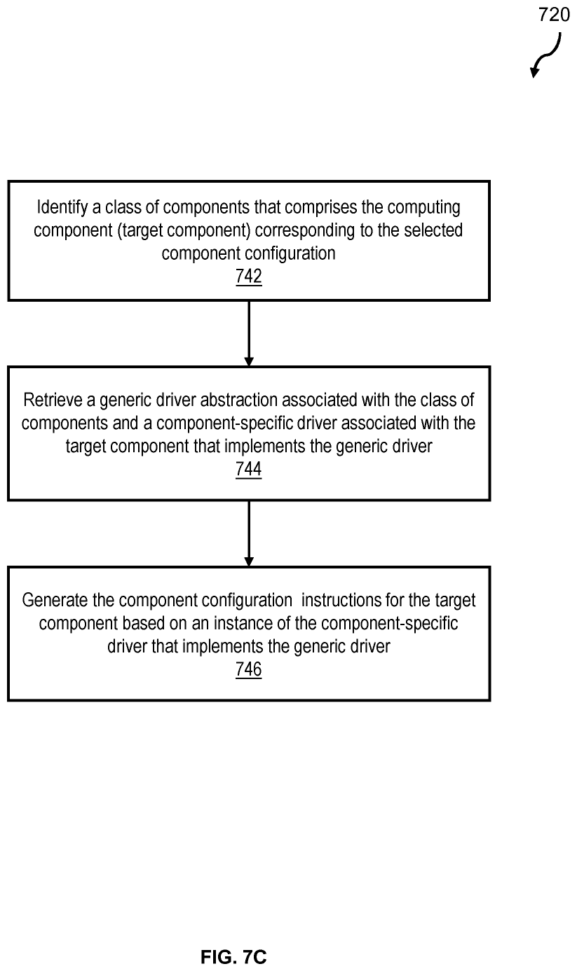

In one or more embodiments, configuration engine 610 refers to hardware and/or software configured to perform operations described herein for programmatically reprovisioning computing platform configurations, referred to as baremetal systems. Examples of operations for programmatically reprovisioning baremetal systems are described below with reference to FIGS. 7A-7C.

In one or more embodiments, the configuration engine 610 receives a reprovisioning request 630, via the interface 650, that requests reprovisioning of a baremetal system 640. The baremetal system 640 includes one or more computing components 642. Computing components 642 for a given baremetal system 640 can include, for example, a central processing unit (CPU), a graphics processing unit (GPU), a root of trust device (ROT), a network interface card (NIC), volatile memory, non-volatile memory, a storage device, buses, switches, fans, and so forth.

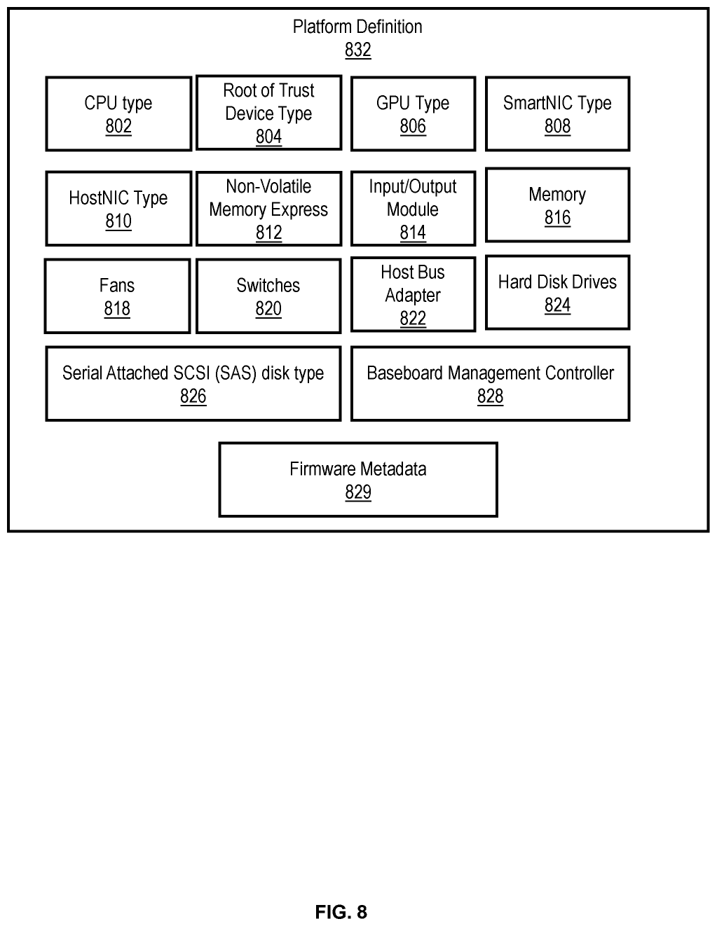

The request 630 may include a platform definition 632. The platform definition 632 may identify and define each computing component 642 included on the baremetal system 640 that is to be reprovisioned. For a given computing component in the baremetal system 640, the platform definition 632 may include, for example, an identification number for the computing component, a manufacturer, a model or version number, a firmware version, and/or a driver version. An example of a platform definition is described with respect to FIG. 8.

In one or more embodiments, the configuration engine 610 retrieves component configurations 622 for each computing component included in the platform definition 632. A component configuration 622 may include specific settings for the properties of the computing component. For example, a component configuration may include information identifying a driver to install and/or a firmware version to install. A component configuration may identify a dependency of the component on another component. A component configuration may include validation criteria for use in checking that the computing component was correctly provisioned.

In one or more embodiments, the dependency graph generator 612 refers to hardware and/or software configured to perform operations described herein for generating a dependency graph. The dependency graph generator 612 may, for example, create a dependency graph node for each computing component in the platform definition 632, and directed edges between two nodes according to a dependency from one node to the other node according to the component configurations.

In one or more embodiments, the configuration engine 610 retrieves component configuration instructions 624 for each computing component in the platform definition. The configuration instructions 624 for a particular computing component may include code, a script, or other instructions that define how a component is provisioned for reuse. For example, the configuration instructions may include steps for erasing or wiping data securely from a device. The configuration instructions may include steps for installing or updating firmware.

In one or more embodiments, the configuration engine 610 uses the retrieved component configuration instructions 624 to generate system configuration instructions 625. The system configuration instructions 625 may include the retrieved component configuration instructions 624 arranged for execution in an order indicated by the dependency graph. For example, if a component B is dependent on a component A, then the system configuration instructions 625 may include the component configuration instructions for component A followed by the component configuration instructions for component B. In one or more embodiments, the system configuration instructions may be compiled to generate an executable file. The configuration engine 610 may then execute the system configuration instructions to reprovision the computing components in the baremetal system.

In one or more embodiments, the dynamic state machine generator 614 may generate the system configuration instructions in the form of a dynamic state machine 629. The dynamic state machine may include a state node for each node in the dependency graph. When the provisioning operations for one state are completed, the dynamic state machine transitions from that state to the next state according to the order derived from the dependency graph. The dynamic state machine will include states for only the computing components included in the platform definition.

In one or more embodiments, component configuration instructions 624 for a component may include one or more generic drivers 626 and one or more component drivers 628. A generic driver 626 may be an abstract class or an interface that defines one or more aspects of the abstract class or interface, such as a type, a variable, or a function. A “child” generic driver may extend a “parent” generic driver and add more aspects to the aspects of the extended parent generic driver. A component driver 628 implements a generic driver, along with any parent generic drivers, and provides values for any variables in the implemented generic driver(s) and instructions for any functions in the implemented generic driver(s) to create a useable set of configuration instructions for the computing component. In this way, whenever a new computing component is introduced to the system 100, only the new computing component's component configuration instructions need to be provided for future provisioning. The generic drivers provide a standardized interface when generating the system configuration instructions.

By way of example, a generic SmartNIC driver may have abstractions for: power on, power off, assert protect pin on/off, reboot, read serial, write serial, install system applications. A component specific driver for a SmartNIC for one manufacturer will include actual component configuration instructions for the abstractions, while a second component specific driver for a SmartNIC for a different manufacturer will include different component configuration instructions for the abstract functions.

In one or more embodiments, a data repository 620 is any type of storage unit and/or device (e.g., a file system, database, collection of tables, or any other storage mechanism) for storing data. Further, a data repository 620 may include multiple different storage units and/or devices. The multiple different storage units and/or devices may or may not be of the same type or located at the same physical site. Further, a data repository 620 may be implemented or executed on the same computing system as the configuration engine 610. Alternatively, or additionally, a data repository 620 may be implemented or executed on a computing system separate from the configuration engine 610. The data repository 620 may be communicatively coupled to the configuration engine 610 via a direct connection or via a network. Additional embodiments and/or examples relating to computer networks are described below in Section 7, titled “Computer Networks and Cloud Networks.”

Information describing component configurations 622, component configuration instructions 624, system configuration instructions 625, generic drivers 626, component drivers 628 and dynamic state machines 629 may be implemented across any of components within the system 600. However, this information is illustrated within the data repository 620 for purposes of clarity and explanation.

In an embodiment, the configuration engine 610 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 650 refers to hardware and/or software configured to facilitate communications between a user and the configuration engine 610. Interface 650 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 650 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 650 is specified in one or more other languages, such as Java, C, or C++.

### 4. PROGRAMMATICALLY REPROVISIONING BAREMETAL SYSTEMS

FIGS. 7A-7C illustrate an example set of operations for programmatically reprovisioning baremetal systems in accordance with one or more embodiments. One or more operations illustrated in FIGS. 7A-7C may be modified, rearranged, or omitted all together. Accordingly, the particular sequence of operations illustrated in FIGS. 7A-7C should not be construed as limiting the scope of one or more embodiments.

The system may receive a request to reprovision a baremetal system comprising a set of computing components (Operation 702). The request may include a platform definition of the computing components. The request may be received via the interface. The request may be submitted by the client returning the baremetal system to the cloud service provider for reuse, or may be triggered programmatically by the system when the client returns the baremetal system. In one or more embodiments, the request indicates that the computing components in the platform definition are to be cleared of any data (“wiped”) and that the most recent versions of firmware and/or drivers should be installed. In other embodiments, the request may also specify particular versions of firmware or a driver that should be installed for a computing component in the platform definition. The platform definition may be provided, for example, as a list of computing components in the request. Alternatively, the platform definition may be provided as a link, reference or pointer, in the request, to a platform definition stored elsewhere.

The system may select a computing component in the platform definition (Operation 704). In some embodiments, the system may programmatically start with the first element in the platform definition. Alternatively, the system may programmatically select a specific computing component first, regardless of where the computing component appears in the platform definition. For example, the system may select a Root of Trust (RoT) component first.

The system may determine whether the selected computing component has sub-components (Operation 706). Some computing components, e.g., a network interface controller (NIC), may themselves be a set of computing components including processors and memory. In some embodiments, the platform definition for such a computing component may include the sub-components within the platform definition and the system may programmatically check for sub-components within each computing component. In other embodiments, the system may programmatically parse or examine a component configuration for the computing component to determine that a computing component has sub-components.

When the selected component does not have any sub-components, the system may retrieve a component configuration for the selected component (Operation 708). For example, the system may programmatically identify a component part number in the platform definition. The component part number is a unique part number assigned to a type of component. The system can use the component part number to programmatically generate and execute a query on a database or other data store to retrieve a corresponding component configuration that includes the specific properties of the computing component. The properties may include, for example, which component configuration instructions to use, which firmware version to install, and/or how many of that computing component to expect. The component configuration may include an indication of a dependency of the computing component on another computing component. The component configuration may identify another computing component that is a compatible part for the selected computing component. A compatible part may have component configuration instructions that can be used for the computing component with which it is compatible.

The system may determine whether there are any remaining components in the platform definition (Operation 710). When there are remaining components, the system returns to Operation 704 to select another computing component.

When a component has sub-components, the system may select a sub-component and retrieve a component configuration for the selected sub-component (Operation 714) as in Operations 708.

The system may determine whether there are any remaining sub-components within the selected component (Operation 716). When there are remaining sub-components, the system returns to Operation 714. When there are no remaining sub-components, the system continues to Operation 710.

When there are no remaining components in the platform definition, the system may programmatically generate a dependency graph (Operation 712). The system may programmatically visit each computing configuration and create a dependency graph node for each computing component in the platform definition and add the dependency graph node to a set of nodes. The system may iteratively execute code that identifies, for each computing component, a dependency on another computing component. When a dependency exists, the system may create a directed edge connecting the two nodes to indicate the dependency between the two components. The system may repeat the process until no new nodes and no new directed edges are created. Dependency in this context may indicate that a computing component must wait for the computing component on which it depends to be provisioned before the dependent computing component can be provisioned.

The system may be programmed to group components which are dependent on each other into component groups. Component groups are dependent groups of components put together. For example, a BMC group can contain a root of trust (RoT) device and a BMC, which depends on the RoT. A network group can contain a NIC, a SmartNIC, and any network peripheral components that establish communication with the baremetal system. A graphics processing unit (GPU) group can contain a GPU, a NIC, and a solid-state drive (SSD). In one or more embodiments, the BMC group, or at least the RoT computing component, does not depend on any other group, and has at least one other group or computing component dependent on it.

The system may select a component configuration from the retrieved component configurations (Operation 718). The system may, for example, first select the component configuration corresponding to the first element in the platform definition, or the root node in the dependency graph. Subsequent selections may be made in an order that follows an ordering in the platform definition or an ordering in the dependency graph.

The system may retrieve component configuration instructions for configuring the component according to the selected component configuration (Operation 720). In one or more embodiments, the system generates and executes a query based on the component part number and/or other information from the platform definition to retrieve component configuration instructions corresponding to the component configuration. For example, if a component configuration specifies a firmware version for the computing component, the system may retrieve the component configuration instructions that use the specified firmware version.

The system may determine whether there are any remaining component configurations to retrieve (Operation 722). When there are remaining component configurations to retrieve, the system returns to Operation 718.

When there are no remaining component configurations to retrieve, the system generates system configuration instructions based on the component configuration instructions and the dependency graph (Operation 724). The system may create a file or other data structure and add the component configuration instructions for each computing component to the file or data structure as a single set of instructions. The component configuration instructions may be arranged in an order such that the instructions corresponding to a root node in the dependency graph are first in an execution order, and component configuration instructions for computing components that depend on the root node computing component occur after the first instructions. Some component configuration instructions may include two or more processes, such as a wipe process, an install/update firmware process, and a validation process. These processes may have a dependency that creates an ordering requirement. The system may use the process dependencies in ordering the system configuration instructions.

In one or more embodiments, when two computing components, or component groups, are not dependent on each other, the system configuration components may include parallel sets of instructions that can be executed independently of the other. In one or more embodiments, the system may compile the system configuration instructions into an executable file.

The system may reprovision the computing components by executing the system configuration instructions (Operation 726). For example, in a baremetal system where the RoT must be updated first before the BMC can be wiped, the system may connect to the RoT directly, or via a network, and execute a portion of the system configuration instructions corresponding to updating the firmware on the RoT. The system may execute a query on a data store to retrieve the firmware for the RoT, and then write the firmware to the RoT. Once the ROT firmware is updated, the system may, via the connection to the RoT, execute a portion of the system configuration instructions corresponding to wiping the BMC. The system may erase the data on the BMC, for example, by setting all of the bits to the same value. Once the system configuration instructions corresponding to the BMC group are executed, the system may execute, in parallel, system configuration instructions corresponding to the GPU group and system configuration instructions corresponding to the network group. For example, the system may wipe the SmartNIC and retrieve and update the firmware on the GPU in parallel.

The system may validate the reprovisioned computing components (Operation 728). The component configuration for each computing component may provide the criteria to use when validating that the computing component was correctly provisioned. Validation criteria may include, for example: firmware version; firmware name; and a count of the number of the computing components in the baremetal system. For computing components that are dependent from another computing component, the validation criteria may include a method to check that the dependency is correct. For a storage device, the system may verify or confirm that the storage device has been wiped. For a network component, the system may test that the computing component can connect to a network. The system may confirm that specified values are set in the baremetal system, such as a specific Mac address, IP address, or a boot volume.

The component configuration instructions may include a validation method for the corresponding computing component. The system may pass parameters to the validation method that include the values that the system used to provision the computing component.

In one or more embodiments, the system may validate individual computing components or a component grouping after the component or grouping is provisioned, and before the next component or component grouping is provisioned.

In one or more embodiments, one or more of the validation steps may fail. Validation may fail when the validation criteria for a computing component are not met after provisioning. Validation may fail when an error occurs in provisioning or if a computing component is defective. Validation may fail if a dependency is incorrect or insufficiently defined, or if two computing components are incompatible. Other operations may fail, such as when the system is unable to retrieve a component configuration. This may occur because a component configuration does not exist for a computing component, or because of an error in a part number or other identifying information in the platform definition. When a failure occurs, the system may present a notification, e.g., through the interface, that the failure occurred and may include information about the affected computing component and the nature of the failure.

In one or more embodiments, the component configuration instructions may generically correspond to a type of computing component, e.g., to a SmartNIC or a GPU, without being specific to a particular computing component. The system may generate the system configuration instructions by using information in the component configuration and component-specific drivers to customize the component configuration instructions to a particular computing component. For example, a manufacturer and a firmware version indicated for a computing component may be passed as a variable to component configuration instructions for the computing component, which may then be used to generate the system configuration instructions.

FIG. 7C illustrates an example set of operations for the Operation 720 when generic and component specific drivers are used.

The system may identify a class of components that comprises the computing component (target component) corresponding to the component configuration selected in Operation 718 (Operation 742). A component class may correspond to a type of computing component, e.g., a SmartNIC or a CPU. The particular computing component's component configuration may include a field that includes the class, and the system may programmatically extract the class from the field. Alternatively, the computing component's part number may be mapped to a component class, and the system may query the mapping with the part number to retrieve the component class.

The system may retrieve a generic driver associated with the class of components and a component-specific driver associated with the target component that implements the generic driver (Operation 744). For a SmartNIC computing component, the system may retrieve a SmartNIC generic driver.

The system may generate the component configuration instructions for the target component based on an instance of the component-specific driver that implements the generic driver (Operation 746). The system may use values provided in the component configuration, e.g., firmware version, manufacturer name, and/or firmware file, to select and implement the component specific driver based on the generic driver, along with any specific values provided by the generic driver.

Some computing components may behave differently depending on their firmware version. For example, a NIC card with one firmware version working with one type of CPU architecture may act as a single interface network card, but with a different type of CPU architecture and different firmware version may act as a dual interface card. The system may have a different component specific driver for each of these behaviors, and may use an architecture parameter in the platform definition to select which of the component specific drivers to use.

### 5. EXAMPLE EMBODIMENT

A detailed example is described below for purposes of clarity. Components and/or operations described below should be understood as one specific example which may not be applicable to certain embodiments. Accordingly, components and/or operations described below should not be construed as limiting the scope of any of the claims.

FIG. 8 illustrates an example of a platform definition 832 of a baremetal system. The platform definition 832 may be a list, vector, array, or other set of elements that define the computing components of a particular baremetal system. Each element in a platform definition may include a part number for the corresponding computing component, where each type of computing component has a unique part number.

For example, the platform definition may include one or more of a central processing unit (CPU) type 802, a Root of Trust (RoT) device type 804, and a graphics processing unit (GPU) type 806. Each of the elements 802, 804, 806 and 808 may specify the architecture of the respective computing component on the baremetal system, e.g., a manufacturer, a model, and/or a version number. The platform definition 832 may include a Smart Network Interface Controller (NIC) type 808 and/or a Host NIC type 810.

The platform definition may include a non-volatile memory express (NVME) type 812 that specifies a manufacturer, size and number of NVMEs on the baremetal system. The platform definition may include an input/output module (IOM) type 814 that specifies the manufacturer of IOM device that connects the storage devices on the baremetal system. The platform definition may include a memory type 816 that specifies an amount and type of memory on the baremetal system. The platform definition may include a fan type 818 and a switches type 820 that specifies, respectively, a number of fans on the system for controlling the temperature, and a number and type of switches that connect the computing components to a network infrastructure on the baremetal system.

The platform definition may include a host bus adapter (HBA) type 822 and a hard disk drives (HDD) element 824. The HBA type 822 may specify a manufacturer and/or type of HBA used to connect a large number of disk drives. The HDD element may include a number of disk drives on the baremetal system, a capacity for each disk drive, and/or a manufacturer for each disk drive.

The platform definition may include a serial attached SCSI (SAS) disk type 826 that specifies a disk manufacturer, a number of disks and their respective sizes. The platform definition may include a baseboard management controller (BMC) type 828 that specifies the type of BMC device.

The platform definition may also include firmware metadata 829. The firmware metadata 829 may include manufacturer-release files for one or more of the computing components included in the platform definition.

The platform definition may include fewer elements than those illustrated. For example, the platform definition may include elements for only the computing components that need to be wiped and/or updated. The platform definition may include multiple elements for the same type of computing component. For example, if the corresponding baremetal system includes multiple hard drives, the platform definition may include a separate element for each individual drive. Alternatively, if the corresponding baremetal system includes multiple instances of the same computing component, e.g., multiple CPUs, the platform definition may include one element for the computing component with an indication in the element of the number of that computing component.

In one or more embodiments, two or more computing components may be grouped together as a collection of sub-components. For example, a computing component that comprises a collection of storage disks, referred to a “just a bunch of disks” or JBOD, may include, as sub-components, the disks, a host bus adapter (HBA), and an input/output module (IOM). The platform definition may, accordingly, include a separate platform definition for the JBOD, which may include the sub-components, for example, nested within the platform definition for the JBOD.

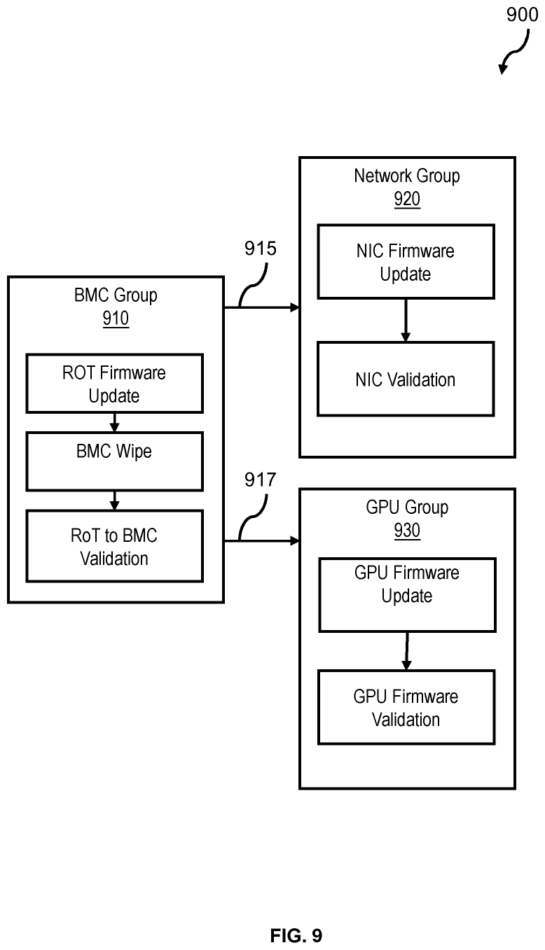

FIG. 9 illustrates an example of a dependency graph 900. The dependency graph 900 includes a BMC group node 910, a network group node 920, and a GPU group node 930. The BMC group node 910 is the root node. The network group node 920 depends on the BMC group node 910 as indicated by the directed edge 915. The GPU group node 930 depends on the BMC group node 910 as indicated by the directed edge 917. There is no directed edge between nodes 920 and 930 because there is no dependency between the nodes.

The dependency graph 900 also includes an ordered set of operations to be performed in each group. For example, in the BMC group, first the ROT firmware is wiped. Next, the BMC is wiped clean. Finally, the ROT and BMC are validated. When generating the system configuration instructions, the system may assemble the ROT firmware wipe instructions from the RoT component configuration instructions, followed by the BMC wipe instructions from the BMC component configuration instructions, and then the validation instructions.

Similarly, the network group and GPU group each have their own set of ordered operations. While the operations within a component group may be dependent on another in-group operation, because the component groups are independent of each other, the operations in the network group can be performed in parallel with the operations in the GPU group, although both groups must wait for the BMC group operations to be completed.

### 6. PRACTICAL APPLICATIONS, ADVANTAGES, AND IMPROVEMENTS

Reprovisioning a baremetal system securely to a cloud service and preparing the baremetal system for onboarding according to a customer requirement has been a challenge. To securely onboard a baremetal system, the baremetal system must be wiped and updated with the firmware to the highest applicable security standards. A conventional approach was to wipe and update the baremetal system as a static configuration of computing components. When a configuration changed, a new reprovisioning process needed to be created for the new configuration. This resulted in a time-consuming process to wipe and the update the baremetal system for onboarding.

Approaching the reprovisioning process on a component-by-component basis rather than from a static configuration as a whole allows for modular and extendable reprovisioning, greatly reducing the amount of time needed to securely wipe and update a baremetal system with new components. When a new computing component is introduced, the system can provision and configure any baremetal system that includes the new computing component once the component configuration and component configuration instructions for the new computing component are added to the system.

### 7. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. MISCELLANEOUS; EXTENSIONS

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y. and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
receiving a request to reprovision a baremetal system, the request comprising a platform definition that defines a plurality of computing components in the baremetal system;
retrieving a first component configuration for a first computing component in the plurality of computing components and a second component configuration for a second computing component in the plurality of computing components, the second component configuration identifying a first dependency of the second computing component on the first computing component;
programmatically generating a dependency graph comprising the first dependency of the second computing component on the first computing component;
retrieving a first set of component configuration instructions for configuring the first computing component in accordance with the first component configuration and a second set of component configuration instructions for configuring the second computing component in accordance with the second component configuration;
generating system configuration instructions based on the first set of component configuration instructions and the second set of component configuration instructions and the dependency graph, wherein (a) a first portion of the system configuration instructions corresponding to the first set of component configuration instructions precede (b) a second portion of the system configuration instructions corresponding to the second set of component configuration instructions in accordance with the dependency graph; and
reprovisioning the baremetal system by executing the system configuration instructions.

2. The non-transitory media of claim 1, the operations further comprising:
retrieving a third component configuration for a third computing component in the plurality of computing components, wherein the second component configuration identifies a second dependency of the second computing component on the third computing component;
generating a second dependency graph comprising the first dependency of the second computing component on the first computing component and the second dependency of the second computing component on the third computing component;
retrieving a third set of component configuration instructions for reconfiguring the third computing component in accordance with the third component configuration;
generating second system configuration instructions based on the first set of component configuration instructions, the second set of component configuration instructions, the third set of component configuration instructions and the dependency graph, wherein a first portion of the second system configuration instructions corresponding to the first set of component configuration instructions and a third portion of the second system configuration instructions corresponding to the third set of component configuration instructions precede a second portion of the system configuration instructions in accordance with the dependency graph; and
reprovisioning the baremetal system by executing the second system configuration instructions.

3. The non-transitory media of claim 1, the operations further comprising:
retrieving a third component configuration for a third computing component in the plurality of computing components, wherein the second component configuration identifies a second dependency of the third computing component on the first computing component;
generating a second dependency graph comprising the first dependency of the second computing component on the first computing component and the second dependency of the third computing component on the first computing component;
retrieving a third set of component configuration instructions for reconfiguring the third computing component in accordance with the third component configuration;
generating second system configuration instructions based on the first set of component configuration instructions, the second set of component configuration instructions, the third set of component configuration instructions and the dependency graph, wherein a first portion of the second system configuration instructions corresponding to the first set of component configuration instructions precedes both a second portion of the system configuration instructions corresponding to the second set of component configuration instructions and a third portion of the second system configuration instructions corresponding to the third set of component configuration instructions, wherein the second portion and the third portion are operative for parallel execution; and
reprovisioning the baremetal system by executing the second system configuration instructions.

4. The non-transitory media of claim 1, wherein the operations further comprise:
subsequent to generating the system configuration instructions, compiling the system configuration instructions to generate an executable file, and wherein executing the system configuration instructions comprises executing the executable file.

5. The non-transitory media of claim 1, the operations further comprising:
subsequent to reprovisioning the baremetal system, portioning the plurality of computing components into a first subgroup of computing components and a second subgroup of computing components such that the computing components within the first subgroup do not depend on other computing components not in the first subgroup and computing components within the second subgroup of computing components do not depend on the second subgroup of computing components; and
sequentially validating the plurality of computing components at least by:
validating the first subgroup of computing components; and
subsequent to validating the first subgroup of computing components, validating the second subgroup of computing components.

6. The non-transitory media of claim 1, the operations further comprising:
subsequent to reprovisioning the baremetal system, attempting to validate the plurality of computing components;
responsive to failing to validate a second component, presenting a notification corresponding to at least one of the first component configuration or the second component configuration.

7. The non-transitory media of claim 1, wherein reprovisioning the first component and the second component comprises:
generating a dynamic state machine based on the dependency graph, the retrieved first set of component configuration instructions and the second set of component configuration instructions; and
executing the dynamic state machine.

8. The non-transitory media of claim 1, the operations further comprising:
retrieving a third component configuration for a third computing component in the plurality of computing components, the third component configuration identifying no dependency of the third computing component on the first computing component or the second computing component;
grouping the first computing component with the second computing component in a first component group and grouping the third computing component in a second component group; and
generating a second dependency graph between the first component group and the second component group.

9. The non-transitory media of claim 1, the operations further comprising:
retrieving a third component configuration for a third computing component in the plurality of computing components, the third component configuration identifying a second dependency relationship of the third computing component to the first computing component and a third dependency relationship of the third computing component to the second computing component;
generating a second dependency graph comprising the first dependency of the second computing component on the first computing component, the second dependency, and the third dependency;
determining that the third computing component does not have a corresponding third set of component configuration instructions;
identifying a fourth compatible computing component from the third component configuration;
retrieving a fourth set of component configuration instructions for the fourth compatible computing component; and
generating second system configuration instructions based on the first set of component configuration instructions, the second set of component configuration instructions, the fourth set of component configuration instructions, and the dependency graph; and
reprovisioning the baremetal system by executing the second system configuration instructions.

10. The non-transitory media of claim 1, wherein programmatically generating the dependency graph comprises:
executing code to:
traverse a plurality of configurations comprising the first component configuration and the second component configuration;
generate a first node corresponding to the first computing component, a second node corresponding to the second computing component, and a directed edge connecting the first node to the second node indicating the first dependency.

11. A method comprising:
receiving a request to reprovision a baremetal system, the request comprising a platform definition that defines a plurality of computing components in the baremetal system;
retrieving a first component configuration for a first computing component in the plurality of computing components and a second component configuration for a second computing component in the plurality of computing components, the second component configuration identifying a first dependency of the second computing component on the first computing component;
generating a dependency graph comprising the first dependency of the second computing component on the first computing component;
retrieving a first set of component configuration instructions for configuring the first computing component in accordance with the first component configuration and a second set of component configuration instructions for configuring the second computing component in accordance with the second component configuration;
generating system configuration instructions based on the first set of component configuration instructions and the second set of component configuration instructions and the dependency graph, wherein (a) a first portion of the system configuration instructions corresponding to the first set of component configuration instructions precede (b) a second portion of the system configuration instructions corresponding to the second set of component configuration instructions in accordance with the dependency graph; and
reprovisioning the baremetal system by executing the system configuration instructions;
wherein the method is performed by at least one device including a hardware processor.

12. The method of claim 11, further comprising:
retrieving a third component configuration for a third computing component in the plurality of computing components, wherein the second component configuration identifies a second dependency of the second computing component on the third computing component;
generating a second dependency graph comprising the first dependency of the second computing component on the first computing component and the second dependency of the second computing component on the third computing component;
retrieving a third set of component configuration instructions for reconfiguring the third computing component in accordance with the third component configuration;
generating second system configuration instructions based on the first set of component configuration instructions, the second set of component configuration instructions, the third set of component configuration instructions and the dependency graph, wherein a first portion of the second system configuration instructions corresponding to the first set of component configuration instructions and a third portion of the second system configuration instructions corresponding to the third set of component configuration instructions precede a second portion of the system configuration instructions in accordance with the dependency graph; and
reprovisioning the baremetal system by executing the second system configuration instructions.

13. The method of claim 11, further comprising:
retrieving a third component configuration for a third computing component in the plurality of computing components, wherein the second component configuration identifies a second dependency of the third computing component on the first computing component;
generating a second dependency graph comprising the first dependency of the second computing component on the first computing component and the second dependency of the third computing component on the first computing component;
retrieving a third set of component configuration instructions for reconfiguring the third computing component in accordance with the third component configuration;
generating second system configuration instructions based on the first set of component configuration instructions, the second set of component configuration instructions, the third set of component configuration instructions and the dependency graph, wherein a first portion of the second system configuration instructions corresponding to the first set of component configuration instructions precedes both a second portion of the system configuration instructions corresponding to the second set of component configuration instructions and a third portion of the second system configuration instructions corresponding to the third set of component configuration instructions, wherein the second portion and the third portion are operative for parallel execution; and
reprovisioning the baremetal system by executing the second system configuration instructions.

14. The method of claim 11, further comprising: subsequent to generating the system configuration instructions, compiling the system configuration instructions to generate an executable file, and wherein executing the system configuration instructions comprises executing the executable file.

15. The method of claim 11, further comprising:
subsequent to reprovisioning the baremetal system, portioning the plurality of computing components into a first subgroup of computing components and a second subgroup of computing components such that the computing components within the first subgroup do not depend on other computing components within the first subgroup and computing components within the second subgroup of computing components do not depend on the second subgroup of computing components; and
sequentially validating the plurality of computing components at least by:
validating the first subgroup of computing components; and
subsequent to validating the first subgroup of computing components, validating the second subgroup of computing components.

16. The method of claim 11, further comprising:
subsequent to reprovisioning the baremetal system, attempting to validate the plurality of computing components;
responsive to failing to validate a second component, presenting a notification corresponding to at least one of the first component configuration or the second component configuration.

17. The method of claim 11, further comprising:
generating a dynamic state machine based on the dependency graph, the retrieved first set of component configuration instructions and the second set of component configuration instructions; and
executing the dynamic state machine.

18. The method of claim 11, further comprising:
retrieving a third component configuration for a third computing component in the plurality of computing components, the third component configuration identifying no dependency of the third computing component on the first computing component or the second computing component;
grouping the first computing component with the second computing component in a first component group and grouping the third computing component in a second component group; and
generating a second dependency graph between the first component group and the second component group.

19. The method of claim 11, further comprising:
retrieving a third component configuration for a third computing component in the plurality of computing components, the third component configuration identifying a second dependency relationship of the third computing component to the first computing component and a third dependency relationship of the third computing component to the second computing component;
generating a second dependency graph comprising the first dependency of the second computing component on the first computing component, the second dependency, and the third dependency;
determining that the third computing component does not have a corresponding third set of component configuration instructions;
identifying a fourth compatible computing component from the third component configuration;
retrieving a fourth set of component configuration instructions for the fourth compatible computing component; and
generating second system configuration instructions based on the first set of component configuration instructions, the second set of component configuration instructions, the fourth set of component configuration instructions, and the dependency graph; and
reprovisioning the baremetal system by executing the second system configuration instructions.

20. A system comprising:
at least one device including a hardware processor;
the system being configured to perform operations comprising:
receiving a request to reprovision a baremetal system, the request comprising a platform definition that defines a plurality of computing components in the baremetal system;
retrieving a first component configuration for a first computing component in the plurality of computing components and a second component configuration for a second computing component in the plurality of computing components, the second component configuration identifying a first dependency of the second computing component on the first computing component;
generating a dependency graph comprising the first dependency of the second computing component on the first computing component;
retrieving a first set of component configuration instructions for configuring the first computing component in accordance with the first component configuration and a second set of component configuration instructions for configuring the second computing component in accordance with the second component configuration;
generating system configuration instructions based on the first set of component configuration instructions and the second set of component configuration instructions and the dependency graph, wherein (a) a first portion of the system configuration instructions corresponding to the first set of component configuration instructions precede (b) a second portion of the system configuration instructions corresponding to the second set of component configuration instructions in accordance with the dependency graph; and
reprovisioning the baremetal system by executing the system configuration instructions;
wherein the method is performed by at least one device including a hardware processor.
